(19) United States
(12) Patent Application Publication
(10) Pub. No.: US 2010/0030535 A1
(43) Pub. Date: Feb. 4, 2010

(54) BASIN MODEL FOR PREDICTING CHANGES IN THE CHEMICAL COMPOSITION OF A RESERVOIR OIL AS A RESULT OF BIODEGRADATION

(76) Inventors: Frank HAESELER, La Garenne Colombes (FR); Françoise Behar, Paris (FR); Pierre-Yves Chenet, Condè Sainte Libiaire (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/533,060

(22) Filed: Jul. 31, 2009

(30) Foreign Application Priority Data
Aug. 1, 2008 (FR) 08/04.436

(51) Int. Cl. G06F 17/10; G06G 7/48; G06G 7/58

(52) U.S. Cl. 703/2; 703/6; 703/11; 703/12

(57) ABSTRACT

Computer-implemented method of determining a composition of hydrocarbons present in a sedimentary basin as a result of biodegradation.

The displacement rates of the hydrocarbons and the displacement rates of the water present in the porous medium are estimated, from a genesis time in a mother rock to a possible accumulation in a reservoir rock. The biodegradation in the entire porous medium is then modelled as a function of time, from the genesis in the mother rock, considering that the hydrocarbon composition varies proportionally to the displacement rates.

### FIELD OF THE INVENTION

The present invention relates to the sphere of petroleum industry. It concerns a method for evaluating the biodegradation of hydrocarbons present in a geological structure such as a petroleum reservoir, as a result of the action of a bacterial population.

The method according to the invention provides a very useful evaluation tool, notably for geologists eager to direct their investigations towards risk zones. In particular, it can be used in the technical field of basin modelling to predict the amount and the quality of the oil that can be expected in connection with the biological alteration that can occur in such environments.

One problem that is commonly encountered when defining the interest of a petroleum objective, i.e. an undrilled hydrocarbon trap, located at a relatively low temperature (usually below 80° C.) is the assessment of the “biodegradation” risk.

In fact, it is commonly recognized that biodegradation, defined as the selective destruction of part of the molecules that make up a petroleum crude by bacteria, can develop up to temperatures that can reach 70° C. to 80° C. Such temperatures are common in particular in marine sediments, which are zones where oil prospecting is currently the most active.

This biodegradation has the effect of modifying the quality of the oil. This quality is measured by the viscosity and the API degree that is inversely proportional to the density. It depends on the composition of the oil (API degree scale between 0 and 40). A high proportion of light hydrocarbons increases the API degree, whereas a high proportion of resins and asphaltenes (NSOs) decreases the API degree. During the geological history of a fluid, thermal maturation tends to lighten reservoir oils and therefore to increase the API degree, while the microbial alteration tends to weight up the oil and therefore to decrease its API degree (Conan et al. 1979 Advances in Organic Geochemistry, Pegamon Press Oxford 1-17 and Peters and Moldowan, 1993, The biomarker guide, Prentice Hall).

Another problem induced by the biodegradation of hydrocarbons is the production of gas (methane and acid gas: CO₂ and H₂S). Some of these gases have an economic value (case of methane) and others reduce the economic value of the reservoir (H₂S).

Biodegradation is a biological phenomenon that can affect the amount and the chemical composition of reservoir oils. The bacteria responsible for these reactions are present in the porous medium and live in the water that circulates in the porous medium. These bacteria use the hydrocarbons as a source of carbon and energy for their development and preservation. They thus, on the one hand, selectively degrade some hydrocarbons and therefore modify both the amount and the composition of the oil in place and, on the other hand, they generate metabolites such as gaseous species (CH₄, H₂S and CO₂) and new chemical structures such as carboxylic acids, However, the acids generated are in turn degraded and they represent in fact only a small part of the residual biodegraded oils. For the bacteria to live, the system also requires ingredients such as electron acceptors and nutriments. Biological reactions need nutriments such as phosphorus and nitrogen, as well as metals, which are essential for the synthesis of the molecules that make up the bacteria. Their absence means bacterial growth arrest.

The biodegradation process can be described as follows. The micro-organisms present in the porous media use the energy and carbon source provided by some hydrocarbon families present in the reservoir oils, with two goals:

develop and produce as much biomass as possible as long as the nitrogen and the phosphorus are not depleted and the trace elements such as metals are no limiting factors,

maintain, i.e. use the energy available through degradation reactions that generate no additional biomass. During such reactions, the hydrocarbons are actually degraded and metabolites are generated, but no biomass increase is observed.

Thus, in the petroleum industry, it is very important to know the role of biodegradation in order to know the quality and the amount of oil expected in a sedimentary basin. In fact biodegradation is a major risk for oil companies whose drilling operations, deep sea drilling for example, represent a considerable financial investment. Any method allowing this risk to be reduced is therefore of major interest for these companies. A method allowing the effect of biodegradation on the amount and the quality of the oil to be assessed is therefore required.

### BACKGROUND OF THE INVENTION

Some authors have been able to assess degradation kinetics by correlating oil residence times in the subsoil with the biodegradation level (Larter et al, 2003 Organic Geochemistry 4, 6001-613, Behar et al, 2006, Organic Geochemistry 37, 1042-1051 et de Barros Penteado et al, 2007, Organic Geochemistry 38, 1197-1211). It essentially consists of a descriptive work that aims to record the biodegradation and its consequences, and to determine specific biodegradation velocities for some basins. In particular, Larter's work allows to predict a biodegradation velocity without taking account of the oil composition, this rate being mainly applied to saturated hydrocarbons. Besides, the mainspring of biodegradation is the diffusion of hydrocarbons in the water/oil contact zone, insofar as this contact zone provides the source of electron acceptors.

A method of predictively assessing the oil biodegradation level in a basin is known from patent EP-1,436,412. This methodology is based on a statistical analysis of the number of bacteria present in the subsoil as a function of depth. Besides, the result of this approach is not compositional.

In general terms, the known methods aim either to describe the biodegradation and not to predict it, or to predict the biodegradation by taking account of the water/oil contact plane to control the biodegradation velocities. These types of method do not take account of factors limiting the activity of micro-organisms: the electron acceptors. Thus, these methods are not really predictive and they require calibration with well data.

The object of the invention thus is a software tool for modelling the compositional evolution of hydrocarbons present in a porous medium as a result of biodegradation.

### SUMMARY OF THE INVENTION

The invention relates to a computer-implemented method of determining a composition of hydrocarbons present in a porous medium of a sedimentary basin, wherein a biodegradation undergone by said hydrocarbons is modelled. It comprises the following stages:

assessing displacement rates of the hydrocarbons and displacement rates of the water present in said porous medium, from a genesis time in a mother rock to a possible accumulation in a reservoir rock, and

modelling the biodegradation in the entire porous medium as a function of time, from the genesis in the mother rock, considering that the hydrocarbon composition varies proportionally to the displacement rates.

According to an embodiment, modelling comprises the following stages:

discretizing said porous medium of said sedimentary basin into a set of grid cells,

defining a biodegradation compositional scheme from at least the following chemical classes: CO₂, H₂S, C₁, C₂-C₄, n-saturated C₆-C₁₄ and iso-saturated C₆-C₁₄, cyclo-saturated C₆-C₁₄, C₆-C₁₄ aromatics, n-saturated C₁₄₊, iso-saturated C₁₄₊, cyclo-saturated C₁₄₊, C₁₄₊ aromatics, NSOs,

determining, at the hydrocarbon genesis time, an amount Cᵢ of each one of said chemical classes contained in said hydrocarbons,

defining a time interval Δt discretizing the time from the hydrocarbon genesis, and for each grid cell and each time interval Δt,

estimating said displacement rates by determining a mean hydrocarbon saturation variation ΔSat_{HC} and a water saturation available for the biodegradation reaction Sat_{WBIO},

determining a temperature T of the porous medium,

determining biodegradation velocities Vᵢ for each one of said chemical classes, as a function of the potential concentration of the chemical classes in the water, their intrinsic biodegradability, their reactivity towards said electron acceptors, the temperature of the medium and the residence time of said hydrocarbons within the medium, and

determining a concentration variation ΔCᵢ of a chemical class i during time interval Δt, from said hydrocarbon amounts, ΔSat_{HC}, Sat_{WBIO}, T and said biodegradation velocities.

According to the invention, concentration variation ΔCᵢ can be determined by means of the following formula:

ΔCᵢ=−Vᵢ(Δt,T)*ΔSat_{HC}*Sat_{WBIO}*Ci(tₙ)*Δt*I_{STERIL},

with:
Δt=tₙ₊₁−tₙ.
I_{STERIL}=1 if temperature T never exceeds a pasteurization temperature,
I_{STERIL}=0 otherwise.

The reaction velocities can be defined by a product of a first term (Rₜ) allowing an effect of the residence time in the porous medium to be taken into account, a second term (R_{T}) allowing an effect of the temperature to be taken into account and a third term (K_{c}) allowing the accessibility and the intrinsic biodegradability of each chemical class to be taken into account.

The first term, Rₜ, can represent a biodegradation efficiency and it can be determined by means of a first evolution curve of efficiency Rₜ as a function of the residence time in the medium. This curve can be an exponential function of time, where efficiency Rₜ is above 95% beyond about 2000 years.

The second term, R_{T}, can represent a biodegradation efficiency and it can be determined by means of a Gaussian evolution curve of efficiency R_{T} as a function of the temperature in the medium. This Gaussian curve is advantageously centered on a temperature of about 30° C. and it is equated to zero for 0° C. and about 70° C.

The third term, V_{c}, can be determined by considering that the intrinsic biodegradability velocity of the saturated C₆-C₁₄ is higher than that of the other classes, and by considering that the maximum accessibility velocity of the C₆-C₁₄ aromatics is higher than that of the other classes.

Thus, the reaction velocities can be defined by:

V C₁₄₋sat=0.4×Vₘₐₓ

V C₁₄₋aro=0.3×Vₘₐₓ

V C₁₄₊n=0.2×Vₘₐₓ

V C₁₄₊iso=0.18×Vₘₐₓ

V C₁₄₊cyclanes=0.08×Vₘₐₓ

V C₁₄₊aro=0.05×Vₘₐₓ

V NSO=0

where Vₘₐₓ is the maximum biodegradation velocity defined by the product of the maximum intrinsic biodegradability velocity by the maximum accessibility velocity.

According to an embodiment, an amount of acid gas produced upon biodegradation is also determined in order to determine development conditions for a reservoir rock of said basin.

Finally, according to another embodiment, an amount of methane produced upon biodegradation is also determined in order to determine development conditions for a reservoir rock of said basin.

### BRIEF DESCRIPTION OF THE FIGURES

Other features and advantages of the method according to the invention will be clear from reading the description hereafter of embodiments given by way of non limitative example, with reference to the accompanying figures wherein:

FIG. 1 shows an example of non-accessibility of the oil to the micro-organisms of the aqueous medium,

FIG. 2 illustrates an example of evolution of the chemical composition of the reservoir oils during an increasing alteration through biodegradation,

FIG. 3 illustrates the evolution, as a function of time t, of term Rₜ allowing the effect of the residence time in the porous medium to be taken into account in the overall biodegradation velocity, and

FIG. 4 illustrates the evolution, as a function of temperature T, of term R_{T} allowing the effect of the temperature to be taken into account in the overall biodegradation velocity.

### DETAILED DESCRIPTION

The method according to the invention allows to qualitatively and quantitatively assess hydrocarbons present in a porous medium of a sedimentary basin after they have undergone biodegradation.

This method is implemented by means of a computer, using a software referred to as “basin model” or “basin simulator” by specialists. An example of such simulators, called TEMIS^{Flow}®, is described in the following document:

Thibaut M., Sulzer C., Jardin A., Bêche M., 2007, ISBA: A Methodological Project for Petroleum Systems Evaluation in Complex Areas, AAPG Congress, Athens.

This basin model allows to model the genesis and the transport of petroleum fluids from a mother rock to the accumulation in a reservoir rock. Within this simulator, genesis is controlled by kinetic equations and transport is controlled by Darcy's law.

According to the invention, the biodegradation undergone by these hydrocarbons during their transport and accumulation is also modelled. Biodegradation is modelled not only at the level of the interface between the hydrocarbons and the water within the petroleum reservoir, but in the entire porous medium that makes up the basin and traversed by the hydrocarbons.

The method therefore allows to model the biodegradation undergone by the hydrocarbons in the entire porous medium, from an estimation of the displacement rates of the hydrocarbons and of the water present in the porous medium, using Darcy's law.

When the first hydrocarbon fluid (oil) leaves the mother rock and circulates in the porous medium, the latter is first filled with water. The oil can enter a porous medium if its pressure P_{hc} can exceed the water pressure plus the capillary pressure of the medium, linked with the pore size, the wettability and the pre-existing hydrocarbon saturation. The following scenarios can then be encountered:

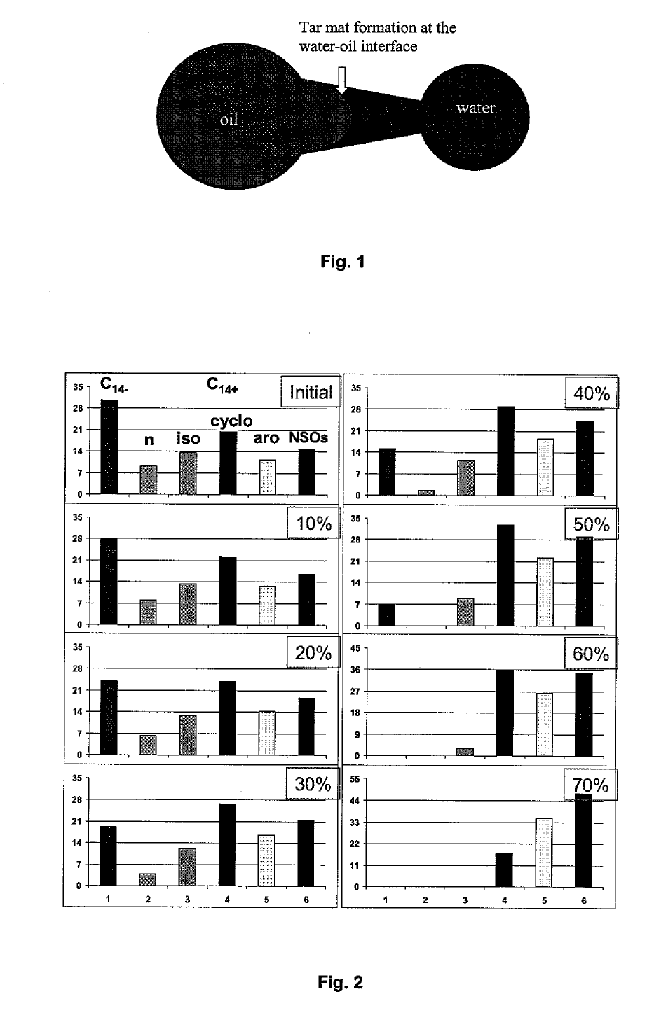

a—the oil flows through a porous medium but it does not accumulate. This is the case of a migration path portion. In this case, the oil saturates the medium only weakly (some %). The oil volume/water volume ratio remains low. If allowed by the temperature conditions, biodegradation may occur, since water is present in sufficient amount, if the hydrocarbon motion velocity is not too high in relation to the biodegradation reaction rate;
b—the oil accumulates in a porous medium. Biodegradation can occur under certain conditions and consume a certain amount of water under methanogenic conditions. Below a certain water saturation, there is no longer access to water, trapped in pores inaccessible to the oil because the size of the pore throat is too small (FIG. 1). The “SatIR_{W-bio}” saturation is the fraction of the irreducible water saturation accessible to micro-organisms. In fact, in clayey media for example, even if the residual water saturations can be sizeable, the water/oil contact will remain very limited because of the capillary forces to overcome; in this case, biodegradation will be stopped very rapidly, as soon as the water/oil contact has allowed formation of a very viscous fluid or tar mat that is going to clog the pores, as illustrated in FIG. 1 that shows an example of non-accessibility of oil to the micro-organisms of the aqueous medium;
c—when the oil flows through the porous medium, the cleared volume is replaced by water. Water being again available, biodegradation can possibly start again. It can alter the residual oil after escape of the mobile oil.

The biodegradation is considered to be proportional to the saturation variation in a given porous volume over time. If there is no saturation variation, the inflow velocity of the hydrocarbons of a given grid cell is the same as the outflow velocity. In this case, the very partial biodegradation of the oil occurs only at the time of the invasion of the porous medium by the oil, as long as there is bioavailable water serving as the electron acceptor for methanogenesis.

Biodegradation also depends on the volume of water consumed during the methanogenesis reaction, and this volume cannot exceed a certain fraction of the porous volume.

At the scale of the elementary movement process in the pores, we practically have a medium that is either totally invaded by oil, which biodegrades through methanogenesis up to the water available for contact, or totally invaded by water.

At the scale of a cell in a basin model, we calculate in practice a mean hydrocarbon saturation variation denoted by ΔSat_{HC}. A saturation in water available for the biodegradation reaction, denoted by SatIR_{WBIO}, is also defined. This saturation is a function of the lithology type. It is low for clays and it reaches maximum levels for spherical porous media (of sand type).

The relative volume of water that has served for biodegradation, in case of complete reaction, will thus be: ΔSat_{HC}*SatIR_{WBIO}.

During a time Δt, these reactions have a certain rate of progress proportional to:

the yield of the overall biodegradation reaction, denoted by R_{bio}(T), that is a function of temperature,

the rate of transformation V_{ci} of a component Ci (considering the accessibility and the intrinsic biodegradability),

the biodegradation efficiency as a function of time R_{bio}(Δt),

the concentration Cᵢ of component I (described by the petroleum genesis).

Finally, if the temperature exceeds a certain value T_{STERIL}, “pasteurization” of the medium takes place (Wilhems A., Larter S. R., Head I., Farrimond P., di Primio R., Zwach C. (2001), Biodegradation of oil in uplifted basins prevented by deep-burial sterilization. Nature, 411: 1034-1037), i.e. the bacteria are definitely killed and the reaction can no longer take place, even if the temperature falls below the sterilization threshold. A sterilization “flag” is then activated with the basin simulator, I_{STERIL}=1, at the time of the porous sediment deposition. If the temperature in a cell is above T_{STERIL}, I_{STERIL}=0.

The concentration variation of a component ΔCᵢ during a time interval Δt is then written between the times tₙ and tₙ₊₁ as a kinetic reaction:

ΔCᵢ=−K_{ci}*Vbio(T)*Vbio(Δt)*ΔSat_{HC}*Sat_{WBIO}*Ci(tₙ)*Δt*I_{STERIL}

with:
Δt: time interval between times tₙ and tₙ₊₁
Ci (tₙ): concentration of a chemical component i at the time tₙ
ΔCᵢ: concentration variation of a chemical component i during time interval Δt
T: temperature
K_{ci}: rate of transformation of a chemical component i (accessibility and biodegradability)
R_{bio}(T): overall biodegradation reaction velocity
R_{bio}(Δt): biodegradation velocity
ΔSat_{HC}: mean hydrocarbon saturation variation
SatIR_{WBIO}: available water saturation for the biodegradation reaction.

If the time interval is large (>50,000 years), the temperature optimum (40° C.) and the saturation variation maximum (100%), we have: ΔCi=−K_{ci}*Sat_{WBIO}*Ci(tₙ)*Δt.

FIG. 2 illustrates the composition variation as a function of the biodegradation progress, by applying a methanogenesis reaction to a reservoir fluid.

According to an embodiment, the method can comprise the following stages:

1-discretizing the porous medium into a set of cells,

2-composition estimation before biodegradation,

3-estimating the fluid displacement rates in the medium and the temperature,

4-estimating the biodegradation velocities,

5-determining the composition variation of the hydrocarbons.

1—Composition Estimation Before Biodegradation

This type of estimation can be conventionally carried out from a tool known to specialists as “basin simulator” or “basin model”. An example of a method used by this type of software tool is described in patent application FR-2,906,482. This application describes a method of modelling the thermal cracking of kerogen and associated petroleum products.

According to this method, a compositional scheme of the hydrocarbons and the non-hydrocarbon gases generated is used. The bacterial action that is the cause of the biodegradation of hydrocarbons generates non-hydrocarbon gases (CO₂, H₂S) and methane (CH₄). It alters more rapidly the n-saturated hydrocarbons and the iso-saturated hydrocarbons. The saturated cyclic structures and the aromatics can then be affected. In principle, sulfur-containing and nitrogen-containing compounds (NSOs) remain unchanged, as well as C₂-C₄ gases, except under extreme conditions. Thus, the a priori order of alteration is as follows: sat C₆-C₁₄ and C₆-C₁₄ aromatics, saturated C₁₄₊.

Thus, according to the invention, the following twelve chemical classes are used for compositional formalization of the fluid (hydrocarbons+gas) biodegradation:

| | |
|---|---|
| Class 1 | CO₂ |
| Class 2 | H₂S |
| Class 3 | C₁ |
| Class 4 | C₂-C₄ |
| Class 5 | n-saturated C₆-C₁₄ and iso-saturated C₆-C₁₄ |
| Class 6 | cyclo-saturated C₆-C₁₄ |
| Class 7 | C₆-C₁₄ aromatics |
| Class 8 | n-saturated C₁₄₊ |
| Class 9 | iso-saturated C₁₄₊ |
| Class 10 | cyclo-saturated C₁₄₊ |
| Class 11 | C₁₄₊ aromatics |
| Class 12 | NSOs |

with the following conventional nomenclature:
C₁: hydrocarbon family with 1 carbon atom
C₂: hydrocarbon family with 2 carbon atoms
C₃: hydrocarbon family with 3 carbon atoms
C₄: hydrocarbon family with 4 carbon atoms
C₆-C₁₄ or C₁₄₋: hydrocarbons having between 6 and 14 carbon atoms
C₁₄₊: hydrocarbons having more than 14 carbon atoms
NSOs: heteroatomic compounds generally of high molecular mass (resins and asphaltenes) containing nitrogen, sulfur and oxygen functions.
Classes 3 to 12 allow to describe the hydrocarbons before and after biodegradation.
Classes 1 and 2 allow to take into account the generation of non-hydrocarbon gas during biodegradation, which is important in order to determine the development conditions of a field.

2—Estimating the Fluid Displacement Rates in the Medium and the Temperature

According to the invention, the fact that biodegradation occurs not only at the level of the interface between the hydrocarbons and the water within the petroleum reservoir, but in the entire porous medium that makes up the basin and traversed by the hydrocarbons is taken into account.

The rate of displacement of the hydrocarbons and of the water present in the porous medium is therefore estimated. At the scale of a flow simulation cell in a basin model, we calculate in practice a mean hydrocarbon saturation variation denoted by ΔSat_{HC}. A saturation in water available for the biodegradation reaction, denoted by SatIR_{WBIO}, is also defined. This saturation is a function of the lithology type. It is low for clays and it reaches maximum levels for spherical porous media (of sand type).

Knowing, in a given time interval, the mean saturation variation, it is possible to determine the rate of displacement of the fluids.

The basin simulator also provides, as it is known to specialists, an estimation of the temperature at each time interval and in any cell.

3—Biodegradation Velocity Estimation

3a—Biodegradation Reaction Scheme

The base unit for biodegradation calculations is the molar concentration Cₘᵢ of the compounds i (chemical classes) taken into account in the compositional scheme. This molar concentration is defined by the formula presented in Equation (1).

$${C}_{mi} = \frac{{C}_{i}}{{M}_{i}} / \frac{{C}_{o}}{{M}_{o}} \qquad ( 1 )$$

with:

Cᵢ: mass concentration of compound i

Mᵢ: molar mass of compound i

Cₒ: mass concentration of the oil

Mₒ: molar mass of the oil.

The molar mass of the oil is a parameter that depends on the characteristics of the petroleum. Its value is a function of the type of kerogen that has caused genesis of the oil, of the thermal history of the petroleum system and in particular the secondary cracking that the petroleum may have undergone. The molar mass of the oil also depends on biodegradation, thus a biodegraded oil is heavier than it was before biodegradation.

Mₒ=f(Type I, II, III), f(thermal history), f(biodegradation)

Mineralization of the hydrocarbons under the action of hydrocarbonoclastic bacteria leads, on the one hand, to the complete disappearance of the hydrocarbons initially present and, on the other hand, to the production of the following final metabolites:

CO₂ and H₂O under aerobic conditions

CO₂, H₂O and N₂ under denitrifying conditions

CO₂, H₂O and H₂S under sulfatoreducing conditions

CO₂ and CH₄ under methanogenic conditions.

These equations describe the hydrocarbon biodegradation pathways with different electron acceptors. They consist of aerobic biodegradation conditions (in the presence of oxygen), denitrifying conditions (in the presence of nitrate), sulfatoreducing conditions (in the presence of sulfate) and methanogenic conditions. This succession of mechanisms involving electron acceptors with an increasingly low oxydoreduction potential can occur only after depletion of the previous electron acceptor.

The sequential biodegradation equations of a hydrocarbon of formula CxHy with the main electron acceptors (O₂, NO₃, SO₄ and H₂O) are presented hereafter

Electron Acceptor: O₂, Aerobic Biodegradation

$$\begin{matrix}{C}_{x} {H}_{y} + ( x + 1 / 4 y ) {O}_{2} {}^{{V}_{{O}_{2}}} \times {CO}_{2} + 1 / 2 y {H}_{2} O & Overall Equation \\ {C}_{16} {H}_{34} + ( 49 / 2 ) {O}_{2} {}^{{V}_{{O}_{2}}} 16 {CO}_{2} + 17 {H}_{2} O . & Example\end{matrix}$$

Electron Acceptor: NO₃, Denitrification

$$\begin{matrix}{C}_{x} {H}_{y} + ( 2 / 3 x + 1 / 6 y ) {NO}_{3} {}^{{V}_{{NO}_{3}^{2 -}}} \times {CO}_{2} + ( 1 / 3 x + 1 / 12 y ) {N}_{2} + 1 / 2 y {H}_{2} O & Overall Equation \\ {C}_{16} {H}_{34} + ( 49 / 3 ) {NO}_{3} {}^{{V}_{{NO}_{3}^{2 -}}} 16 {CO}_{2} + ( 49 / 6 ) {N}_{2} + 17 {H}_{2} O & Example\end{matrix}$$

Electron Acceptor: SO₄, Sulfatoreduction

$$\begin{matrix}{C}_{x} {H}_{y} + ( 2 / 5 x + 1 / 10 y ) {SO}_{4} {}^{{V}_{{SO}_{4}^{2 -}}} \times {CO}_{2} + ( 2 / 5 x + 1 / 10 y ) {H}_{2} S + ( - 2 / 5 x + 2 / 5 y ) {H}_{2} O & Overall Equation \\ {C}_{16} {H}_{34} + ( 98 / 10 ) {SO}_{4} {}^{{V}_{{SO}_{4}^{2 -}}} 16 {CO}_{2} + ( 98 / 10 ) {H}_{2} S + ( 36 / 5 ) {H}_{2} O & Example\end{matrix}$$

Electron Acceptor: H₂O, Methanogenesis

$$\begin{matrix}{C}_{x} {H}_{y} + ( x - 1 / 4 y ) {H}_{2} O {}^{{V}_{{H}_{2} O}} ( 1 / 2 x - 1 / 8 y ) {CO}_{2} + ( 1 / 2 x + 1 / 8 y ) {CH}_{4} & Overall Equation \\ {C}_{16} {H}_{34} + ( 15 / 2 ) {H}_{2} O {}^{{V}_{{H}_{2} O}} ( 15 / 4 ) {CO}_{2} + ( 49 / 4 ) {CH}_{4} & Example\end{matrix}$$

Thus, the biodegradation reaction scheme according to the invention is defined by the following set of chemical reactions:

for each chemical class present in the hydrocarbons, the reactions with the electron acceptors (oxygen, nitrate, sulfate or H₂O) are sequential: each class reacts with the electron acceptor having the highest oxydoreduction potential, up to depletion of this acceptor, then it reacts with the electron acceptor remaining in the medium and having the highest oxydoreduction potential. This mechanism can be repeated up to depletion of the electron acceptors,

the chemical classes react in parallel: there is no sequential mechanism wherein a chemical class would react once another class has stopped reacting. In fact, all the classes can react at the same time, but with different kinetics.

3b—Expressions of the Biodegradation Velocities

The biodegradation velocity equation can be written as follows:

$${V}_{i} = - \frac{\partial {C}_{mi}}{\partial t} = - \frac{{C}_{mi} ( {t}_{n} ) - {C}_{mi} ( {t}_{n - 1} )}{{t}_{n} - {t}_{n - 1}}$$

with:

Cₘᵢ: molar concentration of compound i that undergoes biodegradation

Cₘᵢ(tₙ): molar concentration of compound i at the time tₙ

Cₘᵢ(tₙ₋₁): molar concentration of compound i at the time tₙ₋₁

This velocity Vᵢ is, among other things, a function of the electron acceptor, of the biomass, of compound i, of temperature T, of the fluid hydrodynamics and of the diffusion.

The electron acceptors are: O₂, NO₃, SO₄, H₂O. This parameter depends on the reservoir type. The biomass concerns the nutrient elements (N, P, K) and the trace elements (Fe, Mg, Co . . . ). This parameter also depends on the reservoir type. Compound i is one of the chemical classes defined in the compositional scheme of stage 1. Temperature T is taken into account at a given time (temperature at the time of the reaction), but also according to the thermal history (paleosterilization). The hydrodynamics relates to the displacement of the oil in the reservoir and/or in the migration paths, to the evolution of the oil/water contact and to the water flow rate.

3c—Determining the Overall Biodegradation Velocities

According to the invention, the overall reactions are preferably used. A velocity is assigned to each one of them depending on the chemical class and the electron acceptor. These reaction velocities are referred to as overall velocities.

Thus, the overall velocities of each chemical class of the compositional scheme are determined according, on the one hand, to the hydrocarbon accessibility to bacteria, i.e. their potentially water soluble concentration and, on the other hand, to their intrinsic biodegradability (capacity of micro-organisms to degrade them).

Such an overall velocity is considered to be the product of three terms: a first term (Rₜ) that allows the effect of the residence time in the porous medium to be taken into account, a second term (R_{T}) that allows the effect of temperature to be taken into account and a third term (K_{c}) that allows the specific features of each chemical class to be taken into account.

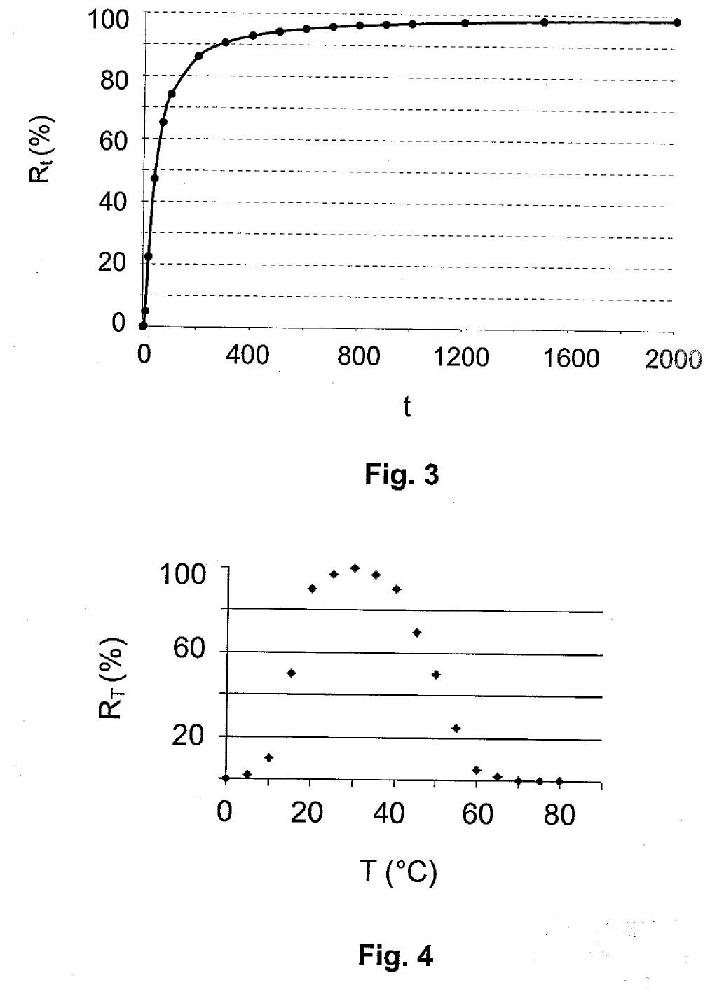

The first term Rₜ) allowing the effect of the residence time in the porous medium to be taken into account represents a biodegradation efficiency. It can be determined from the curve shown in FIG. 3, which illustrates the evolution of the biodegradation efficiency Rₜ (%) as a function of time t (in years). A plateau time (2000 years here) above which the efficiency is higher than 95% and below which the efficiency is all the lower as the time decreases is defined in this figure.

The second term (R_{T}) allowing the effect of temperature to be taken into account represents an overall biodegradation efficiency. It can be determined by considering that overall efficiency R_{T} evolves as a function of temperature according to a Gaussian curve. According to an example illustrated in FIG. 4, this Gaussian curve is centered on a temperature of about 30° C. and it is equated to zero for 0° C. and approximately 70° C.

The third term (V_{c}) allowing the specific features of each chemical class to be taken into account consists of two terms. A first one accounts for the intrinsic biodegradability of the various compound classes. If V_{bio} is the maximum overall biodegradability velocity, the biodegradability of the various hydrocarbon chemical classes can be classified as follows:

(V_{bio})_{C14-sat}=(V_{bio})ₘₐₓ

(V_{bio})_{C14-aro}=0.6×(V_{bio})ₘₐₓ

(V_{bio})_{C14+n}=(V_{bio})ₘₐₓ

(V_{bio})_{C14+iso}=(0.8)×(V_{bio})ₘₐₓ

(V_{bio})_{C14+cyclanes}=(0.3)×(V_{bio})ₘₐₓ

(V_{bio})_{C14+aro}=(0.1)×(V_{bio})ₘₐₓ

(V_{bio})_{C14+nso}=(0.0)×(V_{bio})ₘₐₓ

The second term allowing V_{c} to be defined accounts for the hydrocarbon accessibility in the porous medium, i.e. their capacity to be accessible to bacteria (for example, the C₆-C₁₄ aromatics are the most water soluble hydrocarbons, they therefore have the highest accessibility).

(V_{accès})_{C14-aro}=(V_{accès})ₘₐₓ

(V_{accès})_{C14-sat}=0.4×(V_{accès})ₘₐₓ

(V_{accès})_{C14+chains}=(0.2)×(V_{accès})ₘₐₓ

(V_{accès})_{C14+cyclanes}=(0.2)×(V_{accès})ₘₐₓ

(V_{accès})_{C14+aro}=(0.3)×(V_{accès})ₘₐₓ

(V_{accès})_{C14+nso}=(0.0)×(V_{accès})ₘₐₓ

Thus, the second term V_{c} for the various chemical classes is:

V_{C} C₁₄₋sat=(V_{bio})max×0.4×(V_{accès})max

V_{C} C₁₄₋aro=0.3×(V_{bio})max×(V_{accès})max

V_{C} C₁₄₊n=(V_{bio})max×0.3)×(V_{accès})max

V_{C} C₁₄₊iso=0.7×(V_{bio})max×0.2×(V_{accès})max

V_{C} C₁₄₊cyclanes=0.4×(V_{bio})max×0.2×(V_{accès})max

V_{C} C₁₄₊aro=0.15×(V_{bio})max×0.3×(V_{accès})max

V_{C} NSO=0.

Thus, by taking account of all the terms (Vₘₐₓ=(V_{bio})max×(V_{accès})max), the overall biodegradation velocities (V) for the various chemical classes are as follows:

V C₁₄₋sat=(V_{bio})max×0.4×(V_{accès})max=0.4×Vₘₐₓ
V C₁₄₋aro=0.3×(V_{bio})max×(V_{accès})max=0.3×Vₘₐₓ
V C₁₄₊n=(V_{bio})max×0.3)×(V_{accès})max=0.2×Vₘₐₓ
V C₁₄₊iso=(0.7)×(V_{bio})max×0.2×(V_{accès})max=0.18×Vₘₐₓ
V C₁₄₊cyclanes=(0.4)×(V_{bio})max×(0.2)×(V_{accès})max=0.08×Vₘₐₓ
V C₁₄₊aro=(0.15)×(V_{bio})max×(0.3)×(V_{accès})max=0.05×Vₘₐₓ

### V NSO=0.

4—Determining the Composition Variation of the Hydrocarbons

At each time interval, the concentration variation ΔCi of a chemical class i during time interval Δt is determined by means of the following formula:

If temperature T is higher than a temperature above which there is no more bacterial activity, ΔCi=−Vi(Δt, T)*ΔSat_{HC}*SatIR_{WBIO}*Ci(tn)*Δt, with Δt=tₙ₊₁−tₙ.

The method thus allows to determine the composition of the fluids present in a porous medium as a result of biodegradation. These fluids correspond, on the one hand, to biodegraded hydrocarbons and, on the other hand, to the metabolites produced during this biodegradation, and notably associated gases of biological origin: CH₄, CO₂ and H₂S.

1) A computer-implemented method of determining a composition of hydrocarbons present in a porous medium of a sedimentary basin, wherein a biodegradation undergone by said hydrocarbons is modelled, characterized in that displacement rates of said hydrocarbons and displacement rates of the water present in said porous medium are assessed, from a genesis time in a mother rock to a possible accumulation in a reservoir rock, and the biodegradation in the entire said porous medium is modelled as a function of time, from the genesis in the mother rock, considering that said hydrocarbon composition varies proportionally to said displacement rates.

2) A method as claimed in claim 1, wherein modelling comprises the following stages:
discretizing said porous medium of said sedimentary basin into a set of grid cells,
defining a biodegradation compositional scheme from at least the following chemical classes: CO₂, H₂S, C₁, C₂-C₄, n-saturated C₆-C₁₄ and iso-saturated C₆-C₁₄, cyclo-saturated C₆-C₁₄, C₆-C₁₄ aromatics, n-saturated C₁₄₊, iso-saturated C₁₄₊, cyclo-saturated C₁₄₊, C₁₄₊aromatics, NSOs,
determining, at the hydrocarbon genesis time, an amount Cᵢ of each one of said chemical classes contained in said hydrocarbons,
defining a time interval Δt discretizing the time from the hydrocarbon genesis, and for each grid cell and each time interval Δt,
estimating said displacement rates by determining a mean hydrocarbon saturation variation ΔSat_{HC} and a water saturation available for the biodegradation reaction Sat_{WBIO},
determining a temperature T of the porous medium,
determining biodegradation velocities Vᵢ for each one of said chemical classes, as a function of the potential concentration of the chemical classes in the water, their intrinsic biodegradability, their reactivity towards said electron acceptors, the temperature of the medium and the residence time of said hydrocarbons within the medium, and
determining a concentration variation ΔCᵢ of a chemical class i during time interval Δt, from said hydrocarbon amounts, ΔSat_{HC}, Sat_{WBIO}, T and said biodegradation velocities.

3) A method as claimed in claim 2, wherein concentration variation ΔCᵢ is determined by means of the following formula:
ΔCᵢ=−Vᵢ(t,T)*ΔSat_{HC}*Sat_{WBIO}*Ci(tₙ)*Δt*I_{STERIL},
with:
Δt=tₙ₊₁−tₙ.
I_{STERIL}=1 if temperature T never exceeds a pasteurization temperature,
I_{STERIL}=0 otherwise.

4) A method as claimed in claim 1, wherein said reaction velocities are defined by a product of a first term (Rₜ) allowing an effect of the residence time in the porous medium to be taken into account, a second term (R_{T}) allowing an effect of temperature to be taken into account and a third term (K_{c}) allowing the accessibility and the intrinsic biodegradability of each chemical class to be taken into account.

5) A method as claimed in claim 4, wherein first term Rₜ represents a biodegradation efficiency and it is determined by means of a first evolution curve of said efficiency Rₜ as a function of the residence time in the medium.

6) A method as claimed in claim 5, wherein said first curve is an exponential function of time, where said efficiency Rₜ is above 95% beyond about 2000 years.

7) A method as claimed in claim 4, wherein second term R_{T} represents a biodegradation efficiency and it is determined by means of a Gaussian evolution curve of said efficiency R_{T} as a function of the temperature in the medium.

8) A method as claimed in claim 7, wherein said Gaussian curve is centered on a temperature of about 30° C. and it is equated to zero for 0° C. and about 70° C.

9) A method as claimed in claim 4, wherein third term V_{c} is determined by considering that the intrinsic biodegradability velocity of the saturated C₆-C₁₄ is higher than that of the other classes, and by considering that the maximum accessibility velocity of the C₆-C₁₄ aromatics is higher than that of the other classes.

10) A method as claimed in claim 4, wherein said reaction velocities are defined by:
V C₁₄₋sat=0.4×Vₘₐₓ
V C₁₄₋aro=0.3×Vₘₐₓ
V C₁₄₊n=0.2×Vₘₐₓ
V C₁₄₊iso=0.18×Vₘₐₓ
V C₁₄₊cyclanes=0.08×Vₘₐₓ
V C₁₄₊aro=0.05×Vₘₐₓ
V NSO=0
where Vₘₐₓ is the maximum biodegradation velocity defined by the product of the maximum intrinsic biodegradability velocity by the maximum accessibility velocity.

11) A method as claimed in claim 1, wherein an amount of acid gas produced upon biodegradation is also determined in order to determine development conditions for a reservoir rock of said basin.

12) A method as claimed in claim 1, wherein an amount of methane produced upon biodegradation is also determined in order to determine development conditions for a reservoir rock of said basin.
